(19) United States
(12) Patent Application Publication
(10) Pub. No.: US 2022/0227309 A1
(43) Pub. Date: Jul. 21, 2022

(54) METHOD AND DEVICE FOR DISPLAYING A TOP VIEW IMAGE OF A VEHICLE

(71) Applicants: HYUNDAI MOTOR COMPANY, Seoul (KR); KIA CORPORATION, Seoul (KR)

(72) Inventor: Wontaek Oh, Suwon-si (KR)

(73) Assignees: HYUNDAI MOTOR COMPANY, Seoul (KR); KIA CORPORATION, Seoul (KR)

(21) Appl. No.: 17/505,245

(22) Filed: Oct. 19, 2021

(30) Foreign Application Priority Data
Jan. 18, 2021 (KR) 10-2021-0006648

(51) Int. Cl. B60R 11/04; B60R 11/02

(52) U.S. Cl. CPC B60R 11/04; B60R 11/0229; B60R 2300/105; B60R 2300/806; B60R 2300/607

(57) ABSTRACT

A method of displaying a top view image of a vehicle includes: extracting, by a controller, a location of maximum resolution of a top view image of a vehicle generated by cameras; setting, by the controller, a replacement image area that is larger than an image area of the vehicle included in the top view image of the vehicle by a reference value at the location of the maximum resolution of the top view image of the vehicle; and replacing, by the controller, a non-obtainable mage area of the top view image of the vehicle with the replacement image area, in which the reference value is a value larger than the non-obtainable image area.

### CROSS-REFERENCE TO RELATED APPLICATION

This application claims priority to and the benefit of Korean Patent Application No. 10-2021-0006648 filed in the Korean Intellectual Property Office on Jan. 18, 2021, the entire contents of which are incorporated herein by reference.

### BACKGROUND

### (a) Field of the Disclosure

The present disclosure relates to a driver assistance system (DAS) of a vehicle driver, and more particularly, to a method and a device for displaying a top view image of a vehicle.

### (b) Description of the Related Art

Recently, in order to improve driving safety, an advanced driver assistance system (ADAS) is mounted to a vehicle.

The ADAS includes a lane departure warning system (LDWS), a forward collision warning system (FCWS), a driver drowsiness detection system, a pedestrian detection (PD) system, a traffic signal recognition (TSR) system, a blind-spot view monitoring (BVM) system, or a surround view monitoring (SVM) system.

The SVM system is an image system that can monitor a 360-degree view of the surrounding areas at a glance and is used to photograph images of the surrounding areas and visually check the photographed images,

The above information disclosed in this Background section is only to enhance understanding of the background. Therefore, the Background section may contain information that does not form the prior art that is already known to a person of ordinary skill in the art.

### SUMMARY

The present disclosure has been made in an effort to provide a method and a device for displaying a top view image of a vehicle. The method and device are capable of replacing a non-obtainable image area (or a photographing blind area) of a top view image of a vehicle with a replacement image area to harmonize with a surrounding image of the vehicle.

An embodiment of the present disclosure provides a method of displaying a top view image of a vehicle. The method includes extracting, by a controller, a location of maximum resolution of a top view image of a vehicle generated by cameras. The method also includes setting, by the controller, a replacement image area that is larger than an image area of the vehicle included in the top view image of the vehicle by a reference value at the location of the maximum resolution of the top view image of the vehicle. The method also includes replacing, by the controller, a non-obtainable image area of the top view image of the vehicle with the replacement image area. The reference value is a value larger than the non-obtainable image area.

The method of displaying the top view image of the vehicle may further include replacing, by the controller, the non-obtainable image area of the top view image of the vehicle with the replacement image area according to a movement of an image of the vehicle due to a movement of the vehicle.

The controller may determine a movement direction of the image of the vehicle based on a movement distance of the vehicle detected by a distance sensor and a steering angle of a steering wheel of the vehicle detected by a steering angle sensor.

The controller may replace the non-obtainable image area of the top view image of the vehicle with the replacement image area by using a location coordinate of the image of the vehicle, a location coordinate of the non-obtainable image area of the top view image of the vehicle, and a location coordinate of the replacement image area.

The cameras may include a first camera for obtaining a front image of the vehicle, a second camera for obtaining a rear image of the vehicle, a third camera for obtaining a left image of the vehicle, and a fourth camera for obtaining a right image of the vehicle.

When the third camera has failure, the controller may generate a left image of the vehicle by using the front image of the vehicle of the first camera and the rear image of the vehicle of the second camera.

The controller may generate a shadow image on a boundary of an image of the vehicle surrounded with the replacement image area.

Another embodiment of the present disclosure provides a device for displaying a top view image of a vehicle. The device includes cameras configured to photograph surrounding areas of a vehicle and a controller configured to extract a location of maximum resolution of a top view age of the vehicle generated by the cameras. The controller sets a replacement image area that is larger than an image area of the vehicle included in the top view image of the vehicle by a reference value at the location of the maximum resolution of the top view image of the vehicle. The reference value is a value larger than the non-obtainable image area of the top view image of the vehicle. The controller replaces a non-obtainable image area of the top view image of the vehicle with the replacement image area and controls the display device so as to display the replaced top view image of the vehicle.

The controller may replace the non-obtainable image area of the top view image of the vehicle with the replacement image area according to a 1( )movement of an image of the vehicle due to a movement of the vehicle. The controller may also control the display device so as to display the replaced top view image of the vehicle.

The controller may determine a movement direction of the image of the vehicle based on a movement distance of the vehicle detected by a distance sensor and a steering angle of a steering wheel of the vehicle detected by a steering angle sensor.

The controller may replace the non-obtainable image area of the top view image of the vehicle with the replacement image area by using a location coordinate of the image of the vehicle, a location coordinate of the non-obtainable image area of the top view image of the vehicle, and a location coordinate of the replacement image area.

The cameras may include a first camera for obtaining a front image of the vehicle, a second camera for obtaining a rear image of the vehicle, a third camera for obtaining a left image of the vehicle, and a fourth camera for obtaining a right image of the vehicle.

When the third camera has a failure, the controller may generate a left image of the vehicle by using the front image of the vehicle of the first camera and the rear image of the vehicle of the second camera.

The controller may generate a shadow image on a boundary of an image of the vehicle surrounded with the replacement image area.

The method and the device for displaying the top view image of the vehicle according to the embodiments of the present disclosure may replace a non-obtainable image area (or a photographing blind area) of a top view image of a vehicle with a replacement image area to harmonize with a surrounding image of the vehicle.

### BRIEF DESCRIPTION OF THE DRAWINGS

In order to help more fully understanding the drawings used in the detailed description of the present disclosure, a brief description of each drawing is provided.

FIG. 1 is a flowchart for describing a method of displaying a top view image of a vehicle according to an embodiment of the present disclosure.

FIG. 2 is a diagram for describing a device for displaying a top view image of a vehicle to which the method of displaying a top view image of a vehicle illustrated in FIG. 1 is applied.

FIG. 3 is a diagram describing a replacement image area setting operation illustrated in FIG. 1.

FIG. 4 is a diagram describing a non-obtainable image area replacing operation illustrated in FIG. 1.

FIG. 5 is a diagram describing the non-obtainable image area replacing operation illustrated in FIG. 1.

### DETAILED DESCRIPTION OF THE EMBODIMENTS

In order to fully understand the present inventive concept and the object achieved by carrying out the present disclosure, reference should be made to the accompanying drawings illustrating an embodiments of the present disclosure and the contents disclosed in the accompanying drawings.

Hereinafter, the present disclosure is described in detail by describing the embodiments of the present disclosure with reference to the accompanying drawings. In the following description of the embodiments, a detailed description of known configurations or functions incorporated herein has been omitted where it is judged that the detailed description may make the subject matter of the present disclosure unclear. Also, like reference numerals presented in each drawing designate like elements throughout the specification.

The terms used in the present specification is simply used for describing a specific embodiment and do not intend to limit the present disclosure, singular expression includes a plural expression unless it is specifically described to the contrary in the context. In the present specification, it should be appreciated that the terms “including” and “having” are intended to designate the existence of characteristics, numbers, steps, operations, constituent elements, and components described in the specification or a combination thereof. These terms do not exclude a possibility of the existence or addition of one or more other characteristics, numbers, steps, operations, constituent elements, and components, or a combination thereof in advance.

Throughout this specification, when it is described that an element is “coupled” to another element, the element may be “directly coupled” to the another element or “electrically or mechanically coupled” to the another element with still another element interposed therebetween.

All terms used herein including technical or scientific terms have the same meanings as meanings, which are generally understood by those having ordinary skill in the art to which the present disclosure pertains unless they are differently defined. Terms defined in a generally used dictionary are to be construed to have meanings matching those in the context of a related art and are not to be construed as ideal or excessively formal meanings unless they are clearly defined in the present specification. When a component, device, element, or the like of the present disclosure is described as having a purpose or performing an operation, function, or the like, the component, device, or element should be considered herein as being “configured to” meet that purpose or to perform that operation or function.

Due to a vehicle body including a bumper, an area that cannot be photographed by a camera of a surround view monitoring system (SVM) is generated (present) in a top-view image of a vehicle. The related art displays a vehicle image having a non-obtainable image area (or a shaded area) expressed with a specific color (for example, black) on a top view image of a vehicle or displays a vehicle image having a larger size than that of a vehicle image that needs to be displayed on a top view image.

When the non-obtainable image area is expressed with the specific color, the specific color may not be harmonized with a surrounding image of the vehicle. When the vehicle image having the larger size than that of the vehicle image that needs to be displayed on the top view image is displayed, a width of the vehicle may be exaggerated and displayed.

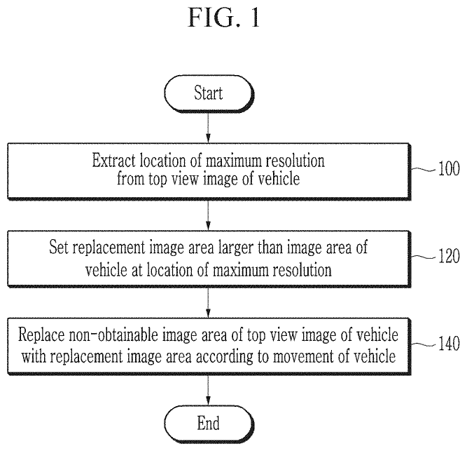

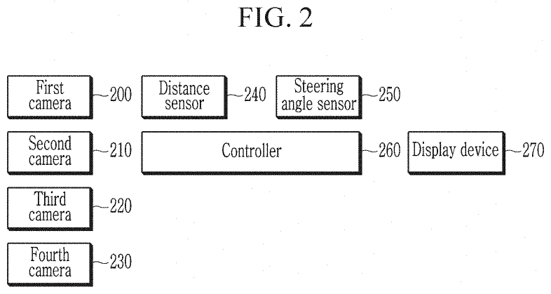

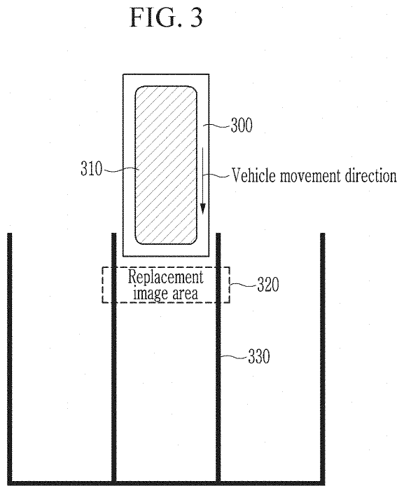

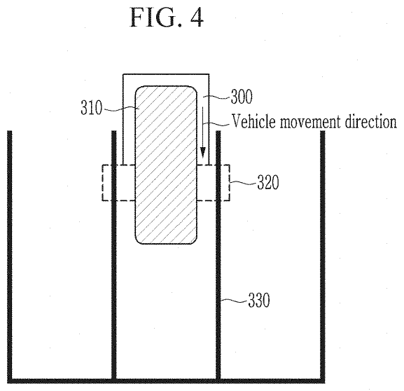

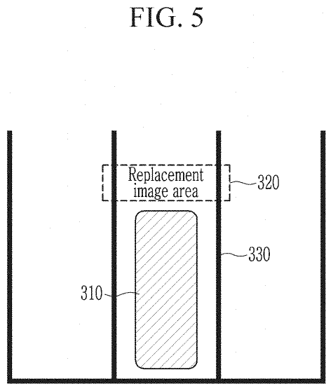

FIG. 1 is a flowchart for describing a method of displaying a top view image of a vehicle according to an embodiment of the present disclosure. FIG. 2 is a diagram for describing a device for displaying a top view image of a vehicle to which the method of displaying a top view image of a vehicle illustrated in FIG. 1 is applied. FIG. 3 is a diagram describing a replacement image area setting operation illustrated in FIG. 1. FIG. 4 is a diagram describing a non-obtainable image area replacing operation illustrated in FIG. 1. FIG. 5 is a diagram describing the non-obtainable image area replacing operation illustrated in FIG. 1.

Referring to FIGS. 1-5, in an extraction operation 100, a controller 260 may extract a location (or location coordinates) of maximum resolution from a top view image of a vehicle generated by cameras photographing the surrounding areas of the vehicle (surrounding images or surrounding situations). The top view image of the vehicle may be a virtual two-dimensional image of the surrounding area of the vehicle viewed from the top of the vehicle. For example, the controller 260 may extract the location of the maximum resolution from the top view image of the vehicle based on locations, types (or specifications (performance)), or optical axis directions of first to fourth cameras 200, 210, 220, and 230 that are the cameras for generating the top view image of the vehicle.

The device for displaying a top view image of a vehicle may include the first camera 200, such as a wide angle camera, the second camera 210 (for example, a wide angle camera), the third camera 220 (for example, a wide angle camera), and the fourth camera 230 (for example, a wide angle camera), a distance sensor 230, a steering angle sensor (SAS) 250, the controller 260, and a display device 270.

The first camera 200 is the front camera, is located on a front surface of the vehicle, and may be used for obtaining (grabbing) a front image of the vehicle. For example, the front camera 200 may be located at a center portion between both headlamps of the vehicle.

The second camera 210 is the rear camera, is located on a rear surface of the vehicle, and may be used for obtaining a rear image of the vehicle. For example, the rear camera 210 may be located at a center portion between both rear lamps of the vehicle.

The third camera 220 is the left camera, is located on a left surface of the vehicle, and may obtain a left image (left-directional image) of the vehicle. For example, the left camera 220 may be located at a left side mirror of the vehicle. For example, when the third camera 220 has a failure, the controller 260 may synthesize or generate a left image of the vehicle by using the front image of the vehicle of the first camera 200 and the rear image of the vehicle of the second camera 210. When the controller 260 displays a top view image of the vehicle by using the left image of the vehicle, the controller 260 may display the left image of the vehicle, which is a virtual image through the display device 270.

The fourth camera 230 is the right camera, is located on a right surface of the vehicle, and may obtain a right image (right-directional image) of the vehicle. For example, the right camera 230 may be located at a right side mirror of the vehicle.

The controller 260 may control the entire operation of the device for displaying a top view image of a vehicle as an Electronic Control Unit (ECU). The controller 260 may be, for example, one or more microprocessors operating by a program (control logic) or hardware (for example, a microcomputer) including the microprocessor. The program may include a series of instructions for performing the method of displaying a top view image of a vehicle according to an embodiment of the present disclosure. The instruction may be stored in a memory of the device for displaying a top view image of a vehicle or the controller 260.

The controller 260 may generate a top view image of the vehicle by combining (synthesizing) the front image of the vehicle of the first camera 200, the rear image of the vehicle of the second camera 210, the left image of the vehicle of the third camera 220, and the right image of the vehicle of the fourth camera 230.

The display device 270 may display the top view image of the vehicle and may display the front image of the vehicle of the first camera 200, the rear image of the vehicle of the second camera 210, the left image of the vehicle of the third camera 220, and the right image of the vehicle of the fourth camera 230. For example, the display device 270 may be a duster of the vehicle.

The first camera 200, the second camera 210, the third camera 220, the fourth camera 230, the controller 260, and the display device 270 may configure a surround view monitor (SVM) system. The SVM system may be a parking assistance system that provides a real-time image of a 360-degree situation around the vehicle as if looking down from above the vehicle. The SVM system may be the device through which the front side, the rear side, the left side, and the right side are visible through four cameras mounted to the vehicle.

According to an operation 120, as illustrated in FIG. 3, the controller 260 may set a replacement image area 320 larger than an area (for example, a width) of an image 310 of the vehicle included in the top view image of the vehicle at a location of the maximum resolution of the top view image of the vehicle. The area (for example, the width) of the replacement image area 320 may be larger than the width of the image 310 of the vehicle by a reference value. The reference value is the value that is larger than the non-obtainable image area (or the photographing blind area) 300 of the top view image of the vehicle (for example, a value obtained by summing a left width and a right width of the non-obtainable image area). The reference value may be determined by a test (or an experiment). The non-obtainable image area 300 may be a shaded area expressed with a specific color (for example, black), which the cameras cannot photograph due to the vehicle body of the vehicle including the bumper. The non-obtainable image area 300 may surround the image 310 of the vehicle. In FIG. 3, reference numeral 330 may be a parking line. The controller 260 may extract a location coordinate of the image 310 of the vehicle, a location coordinate of the replacement image area 320, and a location coordinate of the non-obtainable image area 300 of the top view image of the vehicle from the top view image of the vehicle.

According to an operation 140, as illustrated in FIGS. 4 and 5, the controller 260 may replace (or substitute) the non-obtainable image area 300 of the top view image of the vehicle with the replacement image area 320 according to a movement of the image 310 of the vehicle due to the movement of the vehicle. The controller 260 may control the display device 270 so as to display the replaced top view image of the vehicle. The controller 260 may generate a shadow image on a boundary of the image 310 of the vehicle (for example, a left boundary of the image of the vehicle) surrounded by the replacement image area 320. The shadow image may harmonize the image 310 of the vehicle with the surrounding image of the image of the vehicle.

The image 310 of the vehicle surrounded by the replacement image area 320 may be stored in the memory for later use. The controller 260 may replace (substitute) the non-obtainable image area 300 of the top view image of the vehicle with the replacement image area 320 by using the location coordinate of the image 310 of the vehicle, the location coordinate of the non-obtainable image area 300 of the top view image of the vehicle, and the location coordinate of the replacement image area 320.

The controller 260 may determine or calculate a movement direction of the image 310 of the vehicle based on a movement distance of the vehicle detected by the distance sensor 240 and a steering angle of the steering wheel (or handle) of the vehicle detected by the steering angle sensor 250. The distance sensor 240 may detect the movement distance of the vehicle by using a speed of the vehicle.

In another embodiment of the present disclosure, the controller 260 may replace (substitute) the non-obtainable image area 300 of the top view image of the vehicle with the replacement image area 320 and may control the display device 270 so as to display the replaced top view image of the vehicle even when the image 310 of the vehicle does not move.

The embodiment of the present disclosure may be applied to a three-dimensional view image of the vehicle generable by the first camera 200, the second camera 210, the third camera 220, the fourth camera 230, and the controller 260. For example, the first camera 200 the second camera 210, the third camera 220, and the fourth camera 230 may include a three-dimensional camera. The three-dimensional view image of the vehicle may be a virtual three-dimensional image of the surrounding area of the vehicle viewed from above the vehicle.

The constituent element, e.g. “ . . . unit”, a block, or a module used in the embodiment of the present disclosure, may be implemented by software, such as a task, class, subroutine, process, object, execution thread, and program performed in a predetermined area of a memory, or hardware, such as field-programmable gate array (FPGA) or an application-specific integrated circuit (ASIC). The constituent element, e.g. “ . . . , unit”, a block, or a module used in the embodiment of the present disclosure, may also be implemented by a combination of the software and the hardware. The constituent element, e.g. “ . . . unit” or the like, may also be included in a computer readable storage medium (such as a non-transitory storage medium) and a part thereof may be distributed in the plurality of computers.

As described above, the embodiments have been disclosed in the drawings and the specification. Specific terms are used herein, but are only used for the purpose of describing the present disclosure, and should not used to limit the meaning or the scope of the present disclosure described in the claims. Accordingly, those having ordinary in the art should appreciate that various modifications and equivalent embodiments may be made without departing from the scope and spirit of the present disclosure. Therefore, the true technical protection scope of the present disclosure should be defined by the technical spirit of the accompanying claims.

### DESCRIPTION OF SYMBOLS

200: First camera

210: Second camera

220: Third camera

230: Fourth camera

260: Controller

270: Display device

What is claimed is:

1. A method of displaying a top view image of a vehicle, the method comprising:
extracting, by a controller, a location of maximum resolution of a top view image of a vehicle generated by cameras;
setting, by the controller, a replacement image area that is larger than an image area of the vehicle included in the top view image of the vehicle by a reference value at the location of the maximum resolution of the top view image of the vehicle; and
replacing, by the controller, a non-obtainable image area of the top view image of the vehicle with the replacement image area,
wherein the reference value is a value that is larger than the non-obtainable image area.

2. The method of claim 1, further comprising:
replacing, by the controller, the non-obtainable image area of the top view image of the vehicle with the replacement image area according to a movement of an image of the vehicle due to a movement of the vehicle.

3. The method of claim 2, wherein:
the controller determines a movement direction of the image of the vehicle based on a movement distance of the vehicle detected by a distance sensor and a steering angle of a steering wheel of the vehicle detected by a steering angle sensor.

4. The method of claim 1, wherein:
the controller replaces the non-obtainable image area of the top view image of the vehicle with the replacement image area by using a location coordinate of the image of the vehicle, a location coordinate of the non-obtainable image area of the top view image of the vehicle, and a location coordinate of the replacement image area.

5. The method of claim 1, wherein:
the cameras include a first camera for obtaining a front image of the vehicle, a second camera for obtaining a rear image of the vehicle, a third camera for obtaining a left image of the vehicle, and a fourth camera for obtaining a right image of the vehicle.

6. The method of claim 5, wherein:
when the third camera has a failure, the controller generates a left image of the vehicle by using the front image of the vehicle of the first camera and the rear image of the vehicle of the second camera.

7. The method of claim 1, wherein:
the controller generates a shadow image on a boundary of an image of the vehicle surrounded with the replacement image area.

8. A device for displaying a top view image of a vehicle, the device comprising:
cameras configured to photograph surrounding areas of a vehicle; and
a controller configured to extract a location of maximum resolution of a top view image of the vehicle generated by the cameras,
wherein the controller sets a replacement image area that is larger than an image area of the vehicle included in the top view image of the vehicle by a reference value at the location of the maximum resolution of the top view image of the vehicle, and wherein the reference value is a value that is larger than the non-obtainable image area of the top view image of the vehicle, and
wherein the controller replaces a non-obtainable image area of the top view image of the vehicle with the replacement image area and controls the display device so as to display the replaced top view image of the vehicle.

9. The device of claim 8, wherein:
the controller replaces the non-obtainable image area of the top view image of the vehicle with the replacement image area according to a movement of an image of the vehicle due to a movement of the vehicle, and controls the display device so as to display the replaced top view image of the vehicle.

10. The device of claim herein:
the controller determines a movement direction of the image of the vehicle based on a movement distance of the vehicle detected by a distance sensor and a steering angle of a steering wheel of the vehicle detected by a steering angle sensor.

11. The device of claim 8, wherein:
the controller replaces the non-obtainable image area of the top view image of the vehicle with the replacement image area by using a location coordinate of the image of the vehicle, a location coordinate of the non-obtainable image area of the top view image of the vehicle, and a location coordinate of the replacement image area.

12. The device of claim 8, wherein:
the cameras include a first camera for obtaining a front image of the vehicle, a second camera for obtaining a rear image of the vehicle, a third camera for obtaining a left image of the vehicle, and a fourth camera for obtaining a right image of the vehicle.

13. The device of claim 12, wherein:
when the third camera has failure, the controller generates a left image of the vehicle by using the front image of the vehicle of the first camera and the rear image of the vehicle of the second camera.

14. The device of claim 8. wherein:
the controller generates a shadow image on a boundary of an image of the vehicle surrounded with the replacement image area.
